(19) United States
(12) Patent Application Publication
(10) Pub. No.: US 2010/0247814 A1
(43) Pub. Date: Sep. 30, 2010

(54) ARTIFICIAL TURF STRUCTURE, ARTIFICIAL TURF FACILITIES EMPLOYING THE ARTIFICIAL TURF STRUCTURE AND SYSTEM FOR RECYCLING ARTIFICIAL TURF STRUCTURE

(76) Inventors: Tomoyuki Nisikawa, Hyogo (JP); Takashi Horio, Hyogo (JP)

Correspondence Address: BIRCH STEWART KOLASCH & BIRCH, PO BOX 747, FALLS CHURCH, VA, 22040-0747, US

(21) Appl. No.: 12/745,884

(22) PCT Filed: Nov. 28, 2008
(86) PCT No.: PCT/JP2008/003511

§ 371 Date: Jun. 2, 2010

(30) Foreign Application Priority Data
Dec. 14, 2007 (JP) 2007-323316

(51) Int. Cl. A41G 1/00; B29B 9/00

(52) U.S. Cl. 428/17; 425/11

(57) ABSTRACT

A circulation type technique for recycling an artificial turf structure, in which a spent artificial turf is used as a filler for a fresh artificial turf. A spent artificial turf (3) is melted and formed into a particulate filler (5) for recycling. An artificial turf (3) newly laid on a roadbed is filled with the filler for recycling.

### TECHNICAL FIELD

The present invention relates to an artificial turf structure of a circulation recycling type, more particularly to a system for recycling an artificial turf structure in which a spent artificial turf is formed into a filler for recycling, which is used as a filler for an artificial turf.

### BACKGROUND ART

Artificial turfs such as an artificial turf containing sand and a long pile artificial turf have spread widely as a surface for various sports. Generally, this type of artificial turf structure needs to be renewed after the elapse of its lifetime due to the deterioration of a resin or the break of a pile.

At this time, the spent artificial turf is removed and then disposed of as industrial waste, which is not environmentally desirable. Under these circumstances, there has recently been proposed various techniques for a method of reusing a part of the artificial turf or for an artificial turf which is easily recycled, without treating the artificial turf as industrial waste. A part thereof will be described below.

Patent Document 1 discloses a recyclable artificial turf using nylon 6 as a material in the artificial turf. This patent shows an embodiment in which a recovered artificial turf can be smoothly recycled to a raw material by using nylon 6.

Patent Document 2 discloses an artificial turf prepared by fixing a pile to a primary backing using a thermoplastic resin. According to this patent, the artificial turf itself can be recycled as a raw material for recycling.

Patent Document 1: Japanese Patent Application Publication No. H09-242011

### Patent Document 2: Japanese Patent Application Publication No. 2000-17605

### DISCLOSURE OF THE INVENTION

### Problems to be Solved by the Invention

However, both of the above documents are premised on completely removing the filler from the artificial turf. Actually, since the filler gets wet or is stepped on and hardened with time, it is almost impossible to completely remove the filler entering the pile.

Moreover, particularly with respect to the filler for a long pile artificial turf, the turf has been filled with an elastic filler such as a rubber chip and a hard filler such as sand, these two types of fillers having been stacked, for example, in two layers in order to obtain a filling and properties close to natural turf. Therefore, it has been particularly difficult to completely recover these fillers and separate them into sand and a rubber chip.

Conventionally, the pile and primary backing of an artificial turf have been formed using a thermoplastic resin such as polyethylene as a raw material, and the coating material has been formed using a thermosetting resin such as SBR. For this reason, for recycling such an artificial turf by remelting it, it has been necessary to remove the thermosetting resin, but it has been impossible to completely remove the thermosetting resin.

Therefore, even if the recycling techniques described in Patent Documents 1 and 2 were used, the proportion of impurities was naturally increased, and it was difficult to recycle such an artificial turf to a raw material with high purity. On the other hand, there is a so-called thermal recycling method in which such an artificial turf waste is used as a fuel. However, when an environmental problem is taken into consideration, this method cannot be said to be a desirable method.

Thus, in order to solve the problems as described above, the present invention provides a circulation type technique for recycling an artificial turf structure in which a spent artificial turf is recovered and recycled as a filler which is used as a filler for the repair and maintenance of an artificial turf.

### Means for Solving the Problems

In order to achieve an object mentioned above, the present invention has several features shown below. In accordance with claim 1 of the present invention, an artificial turf structure comprises an artificial turf which comprises a primary backing, piles implanted in the primary backing, and a coating material provided on the back side of the primary backing for fixing the piles to the primary backing, the space between the piles of the artificial turf being filled with a filler, wherein the filler comprises a raw material contained in the artificial turf, and the raw material comprises a thermoplastic resin in an amount of at least 50%.

In accordance with claim 2 of the present invention, the space between the piles is filled with the filler of the same type in the artificial turf structure according to claim 1.

In accordance with claim 3 of the present invention, at least the primary backing and the pile comprise a thermoplastic resin in the artificial turf structure according to claim 1 or 2.

In accordance with claim 4 of the present invention, the thermoplastic resin is PE (polyethylene) or PP (polypropylene) in the artificial turf structure according to claim 2 or 3.

In accordance with claim 5 of the present invention, 50% by weight or more of the thermoplastic resin is low density PE (polyethylene) in the artificial turf structure according to claim 4.

In accordance with claim 6 of the present invention, the coating material comprises SBR latex or urethane in the artificial turf structure according to any one of claims 1 to 5.

In accordance with claim 7 of the present invention, the raw material in the artificial turf is colored in a color other than black in the artificial turf structure according to any one of claims 1 to 6.

As described in claim 8, the present invention includes artificial turf facilities comprising the artificial turf structure.

Further, in accordance with claim 9 of the present invention, an already laid artificial turf is used as a base, and the artificial turf structure is laminated on the base in the artificial turf facilities according to claim 8.

Furthermore, as described in claim 10, the present invention further includes a system for recycling an artificial turf structure comprising an artificial turf which comprises a primary backing, piles implanted in the primary backing, and a coating material for fixing the piles to the primary backing provided on the back side of the primary backing, the space between the piles of the artificial turf being filled with a filler, wherein a spent artificial turf is melted and formed into a particulate filler for recycling, and then an artificial turf newly laid on a base is filled with the filler for recycling.

### ADVANTAGES OF THE INVENTION

In accordance with claim 1 of the present invention, the filler comprises a raw material contained in the artificial turf, the raw material comprising a thermoplastic resin in an amount of at least 50%. Thus, a circulation type artificial turf structure can be obtained by forming a spent artificial turf into a filler for recycling and using the filler for recycling when the artificial turf is renewed. In addition, this artificial turf structure provides good recycling efficiency because even if the filler cannot be completely removed, it can be dissolved together with the spent artificial turf.

Here, the content of the thermoplastic resin in the filler is higher, the more desirable it is because a filler having uniform properties can be obtained. However, when the thermoplastic resin is contained in an amount of at least 50% by weight, the artificial turf can be uniformly distributed through the recycling steps such as grinding, heating, and kneading of the artificial turf even if the artificial turf contains a plurality of materials and contains a thermosetting resin used as a coating material.

In accordance with claim 2 of the present invention, the space between the piles is filled with the filler of the same type. Thus, it is not necessary to classify the filler after it is recovered from the artificial turf, and the adjustment of material is easy when reprocessing the artificial turf.

In accordance with claim 3 of the present invention, the primary backing and the pile comprise a thermoplastic resin. Thus, the dissolution and forming are easy, and the properties can be easily controlled.

In accordance with claims 4 and 5 of the present invention, the thermoplastic resin is PE (polyethylene) or PP (polypropylene), more preferably a low density polyethylene. Thus, the artificial turf can be easily reprocessed because it melts at a relatively low temperature.

In accordance with claim 6 of the present invention, the coating material comprises a thermosetting resin such as SBR latex or urethane. Thus, when the filler is wished to be remade into an elastic filler, the elasticity of SBR and urethane can be used efficiently.

In accordance with claim 7 of the present invention, the raw material in the artificial turf is colored in a color other than black. Thus, the surface of the artificial turf structure can have an aesthetic appearance close to natural turf or the ground and can reflect sunlight to prevent a buildup of heat.

The present invention further includes artificial turf facilities constructed by employing the artificial turf structure. Specifically, the artificial turf facilities can be used as a finished pavement surface of various playgrounds such as a baseball field, a soccer stadium, and a tennis court as well as various facilities such as a driving range, a park, and a promenade.

Moreover, in accordance with claim 9, when the existing artificial turf which has been previously laid is renewed, the existing artificial turf is used as a base, and the artificial turf structure of the present invention is newly installed on the base. Thus, it is possible not only to efficiently use the elasticity of the existing artificial turf, but also to reduce the disposition cost of the existing artificial turf.

In accordance with claim 10 of the present invention, a spent artificial turf is melted and formed into a particulate filler for recycling, and then an artificial turf newly laid on a base is filled with the filler for recycling. Thus, this system is environment-friendly because the spent artificial turf can be recycled as a filler.

In this case, the structure described in the present invention may be directly laid on the existing artificial turf, or may be laid after removing and leveling a part of the existing filler or treating the existing artificial turf surface with a sheet or a coating agent in order to ensure the elasticity, stability, and evenness which are required after laying.

### BRIEF DESCRIPTION OF THE DRAWING

FIG. 1 is a sectional view showing a major portion of an artificial turf structure according to one embodiment of the present invention.

### DESCRIPTION OF SYMBOLS

1 Artificial turf structure
2 Roadbed
3 Artificial turf
31 primary backing
32 coating material
4 Pile
5 Filler

### BEST MODE FOR CARRYING OUT THE INVENTION

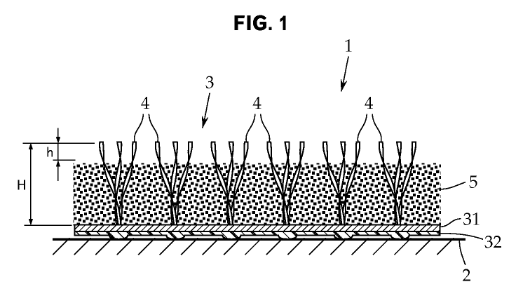

Next, an embodiment of the present invention will be described referring to the drawing, but the present invention is not limited to it. FIG. 1 is a sectional view showing a major portion of an artificial turf structure according to one embodiment of the present invention. This artificial turf structure 1 has an artificial turf 3 laid on a base 2, and the space between piles 4 of the artificial turf 3 is filled with a filler 5.

A low cost road pavement surface in which a ground surface is leveled evenly is used as the base 2. However, the ground may be covered with gravel or the like in addition to the above, or an existing pavement surface paved with asphalt or the like may also be used. Further, an elastic pavement or the like may be provided on the base 2. In the present invention, the structure of the base 2 can be changed depending on specification and is an arbitrary matter.

An artificial turf 3 comprises a primary backing 31 and piles 4 implanted therein with a predetermined interval. A material for the primary backing 31 is preferably selected from a thermoplastic resin such as polypropylene and polyethylene, but low density polyethylene with good meltability is more preferred in consideration of recyclability.

In this embodiment, a green-colored woven cloth is used for the primary backing 31 in order to bring it close to natural turf. However, in addition to this, a cotton-like material of a synthetic resin may be planted by punching to form a primary backing. Note that, although the color of the primary backing 31 is arbitrarily determined depending on specification, the primary backing is preferably colored in a color other than black in consideration of recycling.

The pile 4 is preferably a so-called long pile having a pile length H from the surface of the primary backing 31 to the tip thereof of from 15 to 50 mm. A material for the pile 4 is preferably selected from a thermoplastic resin such as polypropylene and polyethylene, but low density polyethylene with good meltability is more preferred in consideration of recyclability. Although the pile 4 is also colored in green, arbitrary colors other than black may be used.

A bundle of a plurality of monotape yarns or monofilament yarns, or a band of split yarn may be used for the pile 4. In this embodiment, the pile 4 has a size of 8,000 to 11,000 dtex and is planted in the primary backing 31 in a planting amount of 1,000 to 2,000 g/m³.

In order to prevent the tufted pile 4 from being dropped off, a coating material 32 is uniformly applied to the back of the primary backing 31. Although a thermosetting resin such as SBR latex or urethane is used for the coating material 32, an extender such as calcium carbonate is optionally added thereto.

In this embodiment, the coating material 32 is uniformly applied so that the coating amount may be from 600 to 800 g/m² (after drying). The coating material 32 is preferably colored in a color other than black in consideration of the color of the filler for recycling that will be exhibited thereby when it is recycled.

In the present invention, the primary backing 31 and the pile 4 is made using a thermoplastic resin of the same material which is easily melted by heating in consideration of recyclability. A thermosetting resin such as SBR latex is used for the coating material 5 in consideration of workability and the like.

The artificial turf 3 comprises a composite of a thermoplastic resin and a thermosetting resin. Therefore, when the artificial turf 3 is melted by heating, the thermosetting resin will remain as a solid without being melted. Thus, the present invention is constituted so that the content of a thermoplastic resin may be 50% by weight or more of the total resin amount (100% by weight) including the coating material 32.

That is, in the case where the content of a thermoplastic resin is less than 50% by weight of the whole, a thermosetting resin such as a resin for the coating material 32 will not be uniformly mixed with a thermally molten thermoplastic resin, and the resulting mixture cannot be treated as a single material. Therefore, such a case is not preferred.

A material other than a thermoplastic resin can be selected for the coating material 32 in consideration of processability, cost, and the like if the material can fix the pile 4 and satisfies the dimensional stability of the artificial turf 3. However, it is more effective to use a relatively soft material such as SBR and urethane in order to impart moderate elasticity to the filler 5 when the artificial turf is recycled.

The space between the piles 4 of the artificial turf 3 prepared in this way is filled with the filler 5. In the present invention, the filler 5 may be composed only of a recycled article prepared by melting the waste of a spent artificial turf 3 and forming the resulting melt into a particulate, or the filler 5 may be a newly produced one as long as the same material as the artificial turf 3 is contained.

Specifically, even if the filler 5 is prepared by suitably adding other materials to the thermally molten waste of the artificial turf 3 in order to impart color, weight, elasticity and the like, a filler equivalent to the filler 5 composed only of the recycled article can be obtained by controlling the amount of additives to be added to the thermally molten mixture. The resulting filler 5 can be treated as the same material.

The filler 5 preferably consists of a single type of filler. Specifically, if the filler 5 contains a mixture of a plural types of fillers, the filler must be classified after it is removed from the artificial turf. In addition, the proportion of the types of the fillers remaining in the artificial turf 3 may not be uniform. Therefore, there is a risk that the material may not be recycled into a filler 5 having uniform properties by the reprocessing.

The filler 5 is preferably colored in a predetermined color, and more preferably colored in a color other than black. According to this, it is possible not only to obtain an aesthetic appearance close to an artificial turf or the ground, but to prevent a buildup of heat by absorbing sunlight, by coloring the filler 5, for example, in a green-based color or a brown-based color, respectively.

The filling thickness of the filler 5 is arbitrarily selected by the elasticity demanded, but the thickness is preferably selected so that the projection height h of the pile 4 (the length from the top of the layer filled with the filler to the tip of the pile) is from 1 to 30 mm or more in order to prevent an outflow or scattering of the filler 5.

According to the present invention, the artificial turf can be recycled as a material for the artificial turf application and a circulation type recycling system can be established by recovering a spent artificial turf 1 from a roadbed, heating and melting it, forming the melt into a particulate filler for recycling, and then placing the filler for recycling again as a filler of an artificial turf newly laid on a roadbed.

### EXAMPLES

Hereinafter, Examples 1 to 6 of the present invention and Comparative Example 1 will be described. First, the artificial turf was prepared by the following methods.

### (Preparation of Artificial Turf)

The artificial turf was prepared using the pile, primary backing, and coating material in each Example and Comparative Example shown in Table 1.

TABLE 1

| | Materials and the amounts to be used of each member of artificial turf (g/m²) | | | | | | | |
|---|---|---|---|---|---|---|---|---|
| | Pile | | Primary Backing | Coating material | | | | |
| Example 1 | Low density PE | 1300 | PP | 100 | SBR | 200 | Calcium carbonate | 250 |
| Example 2 | Low density PE | 1300 | PP | 100 | SBR | 250 | Calcium carbonate | 500 |
| Example 3 | Low density PE | 1300 | PP | 100 | Urethane | 250 | Calcium carbonate | 500 |
| Example 4 | Low density PE | 1300 | PET | 100 | SBR | 250 | Calcium carbonate | 500 |
| Example 5 | PP | 800 | Low density PE | 100 | SBR | 250 | Calcium carbonate | 500 |
| Example 6 | Low density PE | 1300 | PP | 100 | Acrylic | 250 | Calcium carbonate | 500 |
| Comparative | Low density PE | 600 | PP | 100 | SBR | 250 | Calcium carbonate | 500 |
| Example 1 | | | | | | | | |

### (Recycling of Artificial Turf)

The artificial turf in each Example and Comparative Example was heated and melted and extruded into a plate. The resulting plate was ground to produce a particulate substance (filler for recycling).

Next, various properties and formability of the resulting filler for recycling were observed. In addition, the hardness of the filler for recycling was measured by a hardness measuring method based on JIS-K6253 (the type A method).

The results of the measurements are shown below.

### Example 1

### Materials and the Amounts to be Used of Each Member of Artificial Turf (g/m²)

Pile: Low density polyethylene (1300)
primary backing: Polypropylene (100)
Coating material: SBR (200)+Calcium carbonate (250)
Percentage of thermoplastic resin in constituent resin: 76% by weight
Percentage of low density polyethylene in thermoplastic resin: 93% by weight
Melting temperature: 175° C.
Working time per unit weight: 3 min/kg
Plate forming: Good
Hardness (N number=5): 93 to 95

### Example 2

### Materials and the Amounts to be Used of Each Member of Artificial Turf (g/m²)

Pile: Low density polyethylene (1300)
Primary backing: Polypropylene (100)
Coating material: SBR (250)+Calcium carbonate (500)
Percentage of thermoplastic resin in constituent resin: 65% by weight
Percentage of low density polyethylene in thermoplastic resin: 93% by weight
Melting temperature: 175° C.
Working time per unit weight: 3 min/kg
Plate forming: Good
Hardness (N number=5): 93 to 96

### Example 3

### Materials and the Amounts to be Used of Each Member of Artificial Turf (g/m²)

Pile: Low density polyethylene (1300)
Primary backing: Polypropylene (100)
Coating material: Urethane (250)+Calcium carbonate (500)
Percentage of thermoplastic resin in constituent resin: 65% by weight
Percentage of low density polyethylene in thermoplastic resin: 93% by weight
Melting temperature: 180° C.
Working time per unit weight: 3 min/kg
Plate forming: Good
Hardness (N number=5): 94 to 96

### Example 4

### Materials and the Amounts to be Used of Each Member of Artificial Turf (g/m²)

Pile: Low density polyethylene (1300)
Primary backing: Polyethylene terephthalate (100)
Coating material: SBR (250)+Calcium carbonate (500)
Percentage of thermoplastic resin in constituent resin: 65% by weight
Percentage of low density polyethylene in thermoplastic resin: 93% by weight
Melting temperature: 205° C.
Working time per unit weight: 6 min/kg
Plate forming: Good
Hardness (N number=5): 95 to 98

### Example 5

### Materials and the Amounts to be Used of Each Member of Artificial Turf (g/m²)

### Pile: Polypropylene (800)

Primary backing: Low density polypropylene (100)
Coating material: SBR (250)+Calcium carbonate (500)
Percentage of thermoplastic resin in constituent resin: 55% by weight
Percentage of low density polyethylene in thermoplastic resin: 11% by weight
Melting temperature: 190° C.
Working time per unit weight: 4 min/kg
Plate forming: Good
Hardness (N number=5): 94 to 96

### Example 6

### Materials and the Amounts to be Used of Each Member of Artificial Turf (g/m²)

Pile: Low density polyethylene (1300)
Primary backing: Polypropylene (100)
Coating material: Acrylic (250)+Calcium carbonate (500)
Percentage of thermoplastic resin in constituent resin: 65% by weight
Percentage of low density polyethylene in thermoplastic resin: 93% by weight
Melting temperature: 180° C.
Working time per unit weight: 3 min/kg
Plate forming: Good
Hardness (N number=5): 96 to 99

### Comparative Example 1

### Materials and the Amounts to be Used of Each Member of Artificial Turf (g/m²)

Pile: Low density polyethylene (600)
Primary backing: Polypropylene (100)
Coating material: SBR (250)+Calcium carbonate (500)
Percentage of thermoplastic resin in constituent resin: 48% by weight
Percentage of low density polyethylene in thermoplastic resin: 86% by weight
Melting temperature: 175° C.
Working time per unit weight: 8 min/kg
Plate forming: Good
Hardness (N number=5): 90 to 95

For reference, the results of Examples 1 to 6 and Comparative Example 1 are summarized in Table 2.

TABLE 2

| | Percentage of | Percentage of | | | | |
|---|---|---|---|---|---|---|
| | thermoplastic | low density PE | Melting | Working time | | |
| | resin in | in thermoplastic | temperature | per unit weight | Plate | Hardness |
| | artificial turf [wt %] | resin [wt %] | [° C.] | [min/kg] | forming | [N nubmer = 5] |
| Example 1 | 76 | 93 | 175 | 3 | Good | 93~95 |
| Example 2 | 65 | 93 | 175 | 3 | Good | 93~96 |
| Example 3 | 65 | 93 | 180 | 3 | Good | 94~96 |
| Example 4 | 65 | 93 | 205 | 6 | Good | 95~98 |
| Example 5 | 55 | 11 | 190 | 4 | Good | 94~96 |
| Example 6 | 65 | 93 | 180 | 3 | Good | 96~99 |
| Comparative | 48 | 86 | 180 | 8 | Poor | 90~95 |
| Example 1 | | | | | | |

The following findings were obtained as a result of comparing Examples with Comparative Example.

In Comparative Example 1, since the percentage of the thermoplastic resin in the artificial turf is less than 50% by weight, the material is not uniformly melted, thereby causing a defect during plate forming.

In Example 4, since PET (polyethylene terephthalate) is contained in the thermoplastic resin, the melting temperature increases and the working time is also increased.

In Example 5, since the percentage of the low density polyethylene is low, the melting temperature slightly increases and the working time is also increased.

In Example 6, since acrylic is contained in the coating material, hardness slightly increases.

1.-13. (canceled)

14. An artificial turf structure comprising an artificial turf which comprises a primary backing made using a synthetic resin, piles made using a synthetic resin implanted in the primary backing, and a coating material comprising a thermosetting resin for fixing the piles to the primary backing provided on the back side of the primary backing, the space between the piles of the artificial turf being filled with a filler,
wherein the artificial turf contains a thermoplastic resin in an amount of at least 50% by weight based on the total resin amount including the coating material; the filler comprises a raw material used for the artificial turf, the raw material comprising a thermoplastic resin in an amount of 50% by weight; and the artificial turf can be heated and melted with the space between the piles filled with the filler as a resin raw material for recycling.

15. The artificial turf structure according to claim 14, wherein the filler comprises a recycled resin of the artificial turf which contains a thermoplastic resin in an amount of at least 50% by weight based on the total resin amount including the coating material.

16. The artificial turf structure according to claim 14, wherein the filler comprises a recycled resin of the artificial turf heated and melted with the space between the piles filled with the filler.

17. The artificial turf structure according to any one of claims 14 to 16, wherein the space between the piles is filled with the filler of the same type.

18. The artificial turf structure according to claim 14, wherein at least the primary backing and the pile comprise a thermoplastic resin.

19. The artificial turf structure according to claim 14, wherein the thermoplastic resin is PE (polyethylene) or PP (polypropylene).

20. The artificial turf structure according to claim 14, wherein 50% by weight or more of the thermoplastic resin is low density PE (polyethylene).

21. The artificial turf structure according to claim 14, wherein the coating material comprises SBR latex or urethane.

22. The artificial turf structure according to claim 14, wherein the raw material in the artificial turf is colored in a color other than black.

23. The artificial turf facilities comprising the artificial turf structure according to claim 14.

24. The artificial turf facilities according to claim 23, wherein an already laid artificial turf is used as a base, and the artificial turf structure is laminated on the base.

25. A system for recycling an artificial turf structure comprising an artificial turf which comprises a primary backing made using a synthetic resin, piles made using a synthetic resin implanted in the primary backing, and a coating material comprising a thermosetting resin for fixing the piles to the primary backing provided on the back side of the primary backing, the space between the piles of the artificial turf being filled with a filler,
wherein the artificial turf contains a thermoplastic resin in an amount of at least 50% by weight based on the total resin amount including the coating material; the filler comprises a raw material used for the artificial turf, the raw material comprising a thermoplastic resin in an amount of 50% by weight; a spent artificial turf is heated and melted with the space between the piles filled with the filler and formed into a particulate filler for recycling, and then an artificial turf newly laid on a base is filled with the filler for recycling.

26. The system for recycling an artificial turf structure according to claim 25, wherein the artificial turf newly laid on the base contains a thermoplastic resin in an amount of at least 50% by weight based on the total resin amount including the coating material.
